(19) United States
(12) Patent Application Publication
(10) Pub. No.: US 2024/0171617 A1
(43) Pub. Date: May 23, 2024

(54) METHOD AND APPARATUS FOR IDENTIFYING DARK WEB WEBSITE IN SCENARIO OF CONCURRENT ACCESS TO A PLURALITY OF PAGES

(71) Applicant: TSINGHUA UNIVERSITY, Beijing (CN)

(72) Inventors: Qi LI, Beijing (CN); Xinhao DENG, Beijing (CN); Xiyuan ZHAO, Beijing (CN); Qilei YIN, Beijing (CN); Zhuotao LIU, Beijing (CN); Mingwei XU, Beijing (CN); Ke XU, Beijing (CN); Jianping WU, Beijing (CN)

(21) Appl. No.: 18/512,265

(22) Filed: Nov. 17, 2023

(30) Foreign Application Priority Data
Nov. 18, 2022 (CN) 202211448375.5

(51) Int. Cl. H04L 9/40; H04L 41/16

(52) U.S. Cl. CPC H04L 63/306; H04L 41/16; H04L 63/1425

(57) ABSTRACT

The present disclosure provides a method and an apparatus for identifying a dark web website in a scenario where a plurality of pages are accessed simultaneously. The method includes: obtaining browsed network traffic packets of websites to be identified, and extracting direction sequence features from the network traffic packets; dividing the direction sequence features into a plurality of subsequence features based on a plurality of sliding windows, and inputting the plurality of subsequence features into a neural network model to extract preset pattern features; analyzing a correlation of the preset pattern features using a target website identification model to obtain a probability result of a target website being accessed; obtaining a target website identification result in the website to be identified based on the probability results and a preset classification model.

### CROSS-REFERENCE TO RELATED APPLICATION

This application claims priority to Chinese Patent Application No. 202211448375.5, filed on Nov. 18, 2021, the entire disclosure of which is incorporated herein by reference.

### TECHNICAL FIELD

The present disclosure belongs to a field of website identification technology for dark network traffic, and in particular to a method and an apparatus for identifying dark net websites in a scenario of concurrent access to a plurality of pages.

### BACKGROUND

Website fingerprinting is a combination of network traffic patterns, including the size and interval of packets during visits to websites. By analyzing the traffic of users browsing websites, even encrypted traffic, the fingerprints of different websites can be extracted, which may identify the websites that the users are browsing. In addition, it may also be applied to monitor and combat dark web crimes.

Traditional encrypted traffic website identification methods are mainly categorized into two types.
(1) Website identification based on manually extracted traffic features. This type of approach utilizes manually constructed features and machine learning algorithms to identify websites, e.g., k-NN classifiers, SVMs, random forests, etc. Such processes require expert knowledge for feature construction, which are costly, and are prone to targeted defenses.
(2) Automatic extraction of traffic features for website identification. With the rise of deep learning, deep learning is also widely used in dark web website identification. For example, convolutional neural networks may automatically extract useful features on the raw traffic to accurately identify websites. However, this type of process fails when the user visits a plurality of tab pages or there is noise in the defense traffic.

Various defenses have been proposed against the above dark website identification methods, which aim to modify the traffic patterns of a particular site and thus hide the site fingerprint. BuFLO fixes the packet transmission rate and thus interferes with the identification, however, other characteristics such as the total amount of data and the number of incoming and outgoing traffic packets can still be exploited by existing website identification methods. Tamaraw and CS-BuFLO aggregate traffic with similar sizes and add padding packets in a group, but they incur significant delays in loading web pages and are not applicable to real-world deployments. A number of lightweight defense methods have been proposed to address the above issues. WTF-PAD uses an adaptive padding mechanism to reduce overhead, which only pads packets under the low channel usage. Front adds packets at the front of a traffic sequence. However, these defense methods are not able to defend against dark website identification methods proposed in the present disclosure.

In order to address the interference of defense, a series of dark website identification methods against defense have been proposed. Such methods mainly enhance the identification capability by strengthening the features and improving the model, such as adding temporal information to the features or applying the self-attention mechanism to enhance the model capability.

In reality, Tor users often open multiple tabs at the same time to access the dark web, and it is necessary to distinguish the obfuscated dark web traffic when identifying the websites, which makes it challenging to solve this class of problems due to the dynamic number of tabs opened by the Tor users, and the dynamics of the time intervals between the tabs. Meanwhile, with the interference of defense, the difficulty of identifying multi-tab dark websites is greatly increased, and there is no research that takes this problem into account.

### SUMMARY

The present disclosure aims to solve at least one of the technical problems in the related art to a certain extent.

To compensate for the shortcomings of the existing technology mentioned above, the present disclosure provides a method for identifying confusing dark network traffic from a plurality of pages.

Another object of the present disclosure is to provide an apparatus for identifying a dark web website in a scenario of concurrent access to a plurality of pages.

In order to achieve the above-mentioned objectives, the present disclosure provides a method for identifying a dark web website in a scenario of concurrent access to a plurality of pages, and the method includes:
obtaining browsed network traffic packets of websites to be identified, and extracting direction sequence features from the network traffic packets;
dividing the direction sequence features into a plurality of subsequence features based on a plurality of sliding windows, and inputting the plurality of subsequence features into a neural network model to extract preset pattern features;
analyzing a correlation of the preset pattern features using a target website identification model to obtain a probability result of a target website being accessed;
obtaining a target website identification result based on the probability result and a preset classification model.

In addition, according to the above-mentioned embodiments of the present disclosure, the method for identifying a dark web website in the scenario of concurrent access to the plurality of pages may also have the following additional technical features.

Furthermore, the classification model includes a plurality of binary classifiers configured to identify whether each website is included in the target website.

Furthermore, dividing the direction sequence features into the plurality of subsequence features based on the plurality of sliding windows includes: splicing the direction sequence features to obtain a traffic loop feature: segmenting the traffic loop feature from different positions by using the plurality of sliding windows to obtain the plurality of subsequence features.

Furthermore, the neural network model includes a first analysis component and a second analysis component. Inputting the plurality of subsequence features into a neural network model to extract preset pattern features includes: inputting the plurality of subsequence features into a convolutional layer and a Batch Norm layer of the first analysis component to output a first local feature vector, connecting the first local feature vector with the plurality of subsequence features, and inputting it into a max pooling layer of the first analysis component to output a first local pattern feature: inputting the first local pattern feature into a convolutional layer and a Batch Norm layer of the second analysis component to output a second local feature vector, connecting the second local feature vector with the first local feature vector, and inputting it into a max pooling layer of the second analysis component to output a second local pattern feature.

Furthermore, the target website identification model includes a multi head top-m attention layer. Analyzing the correlation of the preset pattern features by using the target website identification model to obtain the probability result of the target website being accessed includes: obtaining a projection matrix of a head of a preset number based on the second local pattern feature and the multi head top-m attention layer, and obtaining an output result of the head of the preset number based on the projection matrix and a first preset formula: obtaining an output result of the multi head top-m attention layer based on the output result of the head of the preset number and a linear projection function and using a second preset formula: obtaining the probability result of the target website being accessed by using a third preset formula and according to the output result of the multi head top-m attention layer and a preset network rule.

In order to achieve the above-mentioned objectives, the present disclosure also provides a device for identifying a dark web website in a scenario where a plurality of pages are accessed simultaneously, and the device includes:
a processor; and
a memory for storing instructions executable by the processor.

The processor is configured to:
obtain browsed network traffic packets of websites to be identified, and extract direction sequence features from the network traffic packets;
divide the direction sequence features into a plurality of subsequence features based on a plurality of sliding windows, and input the plurality of subsequence features into a neural network model to extract preset pattern features;
analyze a correlation of the preset pattern features using a target website identification model to obtain a probability result of a target website being accessed;
obtain a target website identification result based on the probability result and a preset classification model.

Furthermore, the classification model comprises a plurality of binary classifiers configured to identify whether each website is included in the target website.

Furthermore, the processor is configured to: splice the direction sequence features to obtain a traffic loop feature: segment the traffic loop feature from different positions by using the plurality of sliding windows to obtain the plurality of subsequence features.

Furthermore, the processor is configured to: input the plurality of subsequence features into a convolutional layer and a Batch Norm layer of the first analysis component to output a first local feature vector, connect the first local feature vector with the plurality of subsequence features, and inputting it into a max pooling layer of the first analysis component to output a first local pattern feature: input the first local pattern feature into a convolutional layer and a Batch Norm layer of the second analysis component to output a second local feature vector, connect the second local feature vector with the first local feature vector, and input it into a max pooling layer of the second analysis component to output a second local pattern feature.

Furthermore, the processor is configured to obtain a projection matrix of a head of a preset number based on the second local pattern feature and a multi head top-m attention layer, and obtain an output result of the head of the preset number based on the projection matrix and a first preset formula; obtain an output result of the multi head top-m attention layer based on the output result of the head of the preset number and a linear projection function and using a second preset formula; obtain the probability determining result of the target website being accessed by using a third preset formula and according to the output result of the multi head top-m attention layer and a preset network rule.

In order to achieve the above-mentioned objectives, the present disclosure also provides a non-transitory computer-readable storage medium having stored therein instructions that, when executed by a processor, causes the processor to:
obtain browsed network traffic packets of websites to be identified, and extract direction sequence features from the network traffic packets;
divide the direction sequence features into a plurality of subsequence features based on a plurality of sliding windows, and input the plurality of subsequence features into a neural network model to extract preset pattern features;
analyze a correlation of the preset pattern features using a target website identification model to obtain a probability determining result of a target website being accessed;
obtain a target website identification result in the website to be identified based on the probability determining result and a preset classification model.

Furthermore, the classification model comprises a plurality of binary classifiers configured to identify whether each website is included in the target website.

Furthermore, the processor is configured to splice the direction sequence features to obtain a traffic loop feature: segment the traffic loop feature from different positions by using the plurality of sliding windows to obtain the plurality of subsequence features.

Furthermore, the processor is configured to input the plurality of subsequence features into a convolutional layer and a Batch Norm layer of the first analysis component to output a first local feature vector, connect the first local feature vector with the plurality of subsequence features, and inputting it into a max pooling layer of the first analysis component to output a first local pattern feature: input the first local pattern feature into a convolutional layer and a Batch Norm layer of the second analysis component to output a second local feature vector, connect the second local feature vector with the first local feature vector, and input it into a max pooling layer of the second analysis component to output a second local pattern feature.

Furthermore, the processor is configured to obtain a projection matrix of a head of a preset number based on the second local pattern feature and a multi head top-m attention layer, and obtain an output result of the head of the preset number based on the projection matrix and a first preset formula: obtain an output result of the multi head top-m attention layer based on the output result of the head of the preset number and a linear projection function and using a second preset formula: obtain the probability determining result of the target website being accessed by using a third preset formula and according to the output result of the multi head top-m attention layer and a preset network rule.

Additional aspects and advantages of embodiments of the present disclosure will be given in part in the following descriptions, become apparent from the following descriptions, or be learned from the practice of embodiments of the present disclosure.

### BRIEF DESCRIPTION OF THE DRAWINGS

The above and/or additional aspects and advantages of the present disclosure will become apparent and easy to understand from the description of embodiments in conjunction with the accompanying drawings, in which:

FIG. 1 shows a threat model for general website identification;

FIG. 2 is a flowchart of a method for identifying dark web website in a scenario of concurrent access to a plurality of pages according to an embodiment of the present disclosure;

FIG. 3 shows an architecture diagram of a method for identifying dark web website in a scenario of concurrent access to a plurality of pages according to an embodiment of the present disclosure;

FIG. 4 is a schematic diagram showing a local analysis module according to an embodiment of the present disclosure;

FIG. 5 is a schematic diagram showing a multi head top-m attention mechanism in a website identification module according to an embodiment of the present disclosure;

FIG. 6 is a block diagram showing an apparatus for identifying dark web website in a scenario of concurrent access to a plurality of tag pages according to an embodiment of the present disclosure.

### DETAILED DESCRIPTION

It is noted that, without conflict, embodiments and features in embodiments of the present disclosure may be combined with each other. The present disclosure will be explained in detail below with reference to the accompanying drawings and embodiments.

The technical solutions in embodiments of the present disclosure will be clearly and completely described below in combination with the accompanying drawings in the embodiments of the present disclosure. Obviously, the described embodiments are a part of the embodiments of the present disclosure, and not all of them. Based on the embodiments of the present disclosure, all other embodiments obtained without inventive works by those skilled in the art fall within the scope of protection of the present disclosure.

The following is a description of a method and an apparatus for identifying dark web website identification in a scenario where a plurality of pages are accessed simultaneously according to embodiments of the present disclosure, with reference to the accompanying drawings.

FIG. 2 is a flowchart of a method for identifying dark web website in a scenario of concurrent access to a plurality of pages according to an embodiment of the present disclosure, which improves the accuracy of website identification without prior knowledge such as the number of websites browsed, and is better suitable for real user browsing scenarios. At the same time, it ensures robustness under the interference of website fingerprinting defense, and is suitable for website identification of various types of encrypted traffic with a smaller overhead.

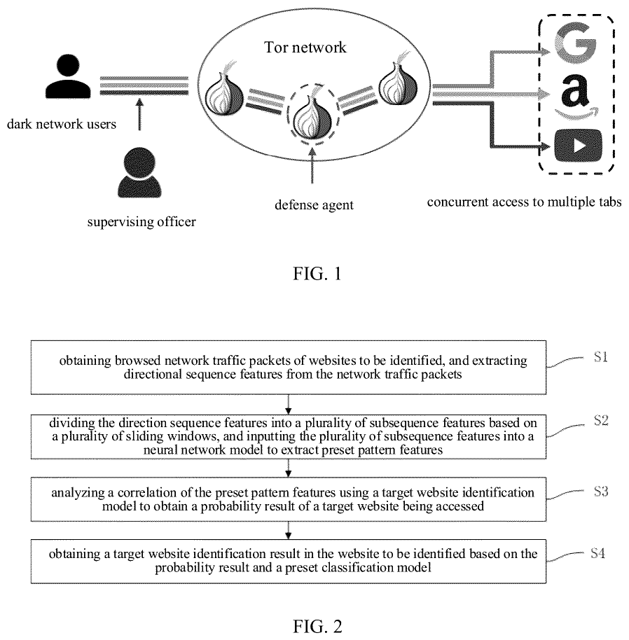

As shown in FIG. 1, the method includes, but is not limited to the following steps.
In step S1, network traffic packets of websites to be identified are obtained, and direction sequence features in the network traffic packets are extracted.

In step S2, based on a plurality of sliding windows, the direction sequence features are divided into a plurality of subsequence features, and the plurality of the subsequence features are input into a neural network model to extract preset pattern features.

In step S3, a target website identification model is used to analyze a correlation of the preset pattern features, so as to obtain a probability result of the target website being accessed.

In step S4, based on the probability result and a preset classification model, the target website identification result is obtained.

The following is a detailed description of a method for identifying dark web website in a scenario where a plurality of pages are accessed simultaneously according to an embodiment of the present disclosure, combined with the accompanying drawings.

As an example, the present disclosure provides a threat model. Users hide their online activities through privacy-preserving mechanisms such as the Tor browser, and they may open multiple browser pages to load multiple pages from different websites at the same time. Thus, a single browsing session of a user may contain encrypted traffic of data from multiple websites. In addition, defenses may be deployed on the user's browser or Tor's relay node, so that traffic patterns from a single website cannot be preserved intact. In the present disclosure, website fingerprinting is utilized to analyze a user's online behavior by inferring the websites that the user browses. The identifier may deploy multiple traffic collection points thus recording the user's encrypted traffic and even get the traffic before entering the Tor network. It is worth mentioning that delaying or dropping the user's web traffic packets is not considered in the present disclosure.

Compared to traditional multi-tab website identification models, FIG. 1 shows a generalized threat model for website identification. The model in the present disclosure is tailored to more realistic and challenging scenarios. Firstly, it accounts for the possibility that users may have deployed defensive measures, hence individual website traffic patterns could be disrupted by such anti-identification tactics. Secondly, it considers the dynamic and previously unknown number of web pages a user may open, whereas previous identification strategies assumed a fixed number of pages, enabling their models to be trained and tested under a consistent page count scenario, which is limited in real-world applicability.

The present disclosure addresses two scenarios, i.e., closed-world and open-world settings. In the closed-world setting, it is presumed that a user only browses a limited collection of websites, known as monitored websites, such as the top 100 visited sites on Alexa. In this context, the identifier can collect training data from all the websites. Conversely, in the open-world setting, a user may browse any website, which means the identifier can only obtain training data from a subset of websites.

The following is a model of a dark web website recognition method provided by the present disclosure in the scenario of concurrent access to a plurality of tag pages.

Previous multi-tab website identification required prior knowledge of the number of web pages opened. To address this issue, the present disclosure conceptualizes website identification in a multi-tab scenario as a multi-label classification problem. Due to the interference between different websites and the noise introduced by defensive measures, training a single classifier to resolve the aforementioned problem is exceedingly challenging. Therefore, the present disclosure has developed a multi-classifier architecture to tackle the multi-label classification issue, with each classifier designed to compute the probability of a specific website being accessed in a given context. Subsequently, the invention integrates the outcomes of each classifier to output the collection of all visited websites in each browsing instance. Furthermore, since local patterns of websites can still be extracted from multiple short traffic sequences, a novel model, Trans-WF, is designed for each classifier to construct robust fingerprints based on these local patterns.

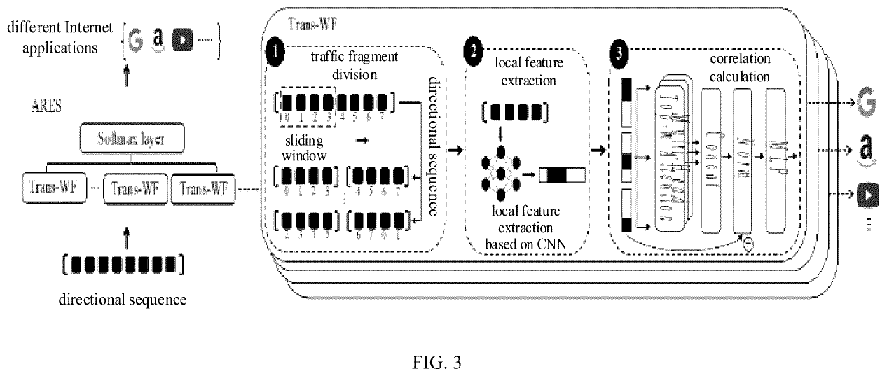

Furthermore, FIG. 3 presents the architectural diagram of the dark web site identification method proposed by the present disclosure for scenarios involving concurrent access across multiple tabs, as delineated in Table 1, which details the significance of the labels used.

TABLE 1

| Label | meaning |
|---|---|
| d | direction sequence |
| y | label representation vector |
| s | individual segment after traffic partitioning |
| l | length of the direction sequence |
| w | size of the sliding window |
| n | number of sliding windows |
| S | set of segments post-traffic partitioning |
| W | set of segments separated by the same sliding window |
| B | block output in the local analysis module |
| Λ | output of the multi head top-m attention layer |
| Φ | identification result of the target website |

In step S11, the Tor user accessing dark websites with multiple opened tabs intercepted, and the direction sequence of traffic is extracted as a feature.

In step S12, the extracted direction sequence features are input into a plurality of binary classifiers, and each binary classifier is configured to identify whether the obfuscated traffic includes the target website.

In step S13, based on a plurality of sliding windows, the direction sequence is divided into a plurality of subsequences.

Specifically, the process involves collecting network traffic packets during a user's website browsing session and extracting the direction sequence from these packets, with outgoing traffic packets denoted as +1 and incoming as −1. The extracted direction sequences are then fed in parallel into multiple classifiers. The traffic partitioning module employs a sliding window technique to divide the collected complete direction sequence into a plurality of segments, preserving the integrity of the local traffic pattern of each segment. Employing a multi-binary classifier architecture, each classifier is responsible for identifying whether the obfuscated traffic contains the target website.

It is understandable that, given the non-uniformity of local traffic patterns, directly partitioning the entire direction sequence into uniformly sized, non-overlapping segments would be inappropriate, as it could disrupt specific local patterns. Moreover, merely increasing the segment size does not guarantee improved outcomes, as it reduces the number of local traffic patterns. Typically, the patterns of a website are associated with the HTML elements of a web page, and the traffic packets related to HTML elements are often concentrated in smaller traffic sequences, thereby forming distinctive local traffic patterns. To ensure the capture of each complete local sub-segment, multiple sliding windows are employed to partition the traffic sequence from various starting points, ensuring that if a segment is disrupted in one window, it can be captured in another. To guarantee that all captured sequences are of the same length, the original segment is concatenated to its end before partitioning, creating a traffic loop. Within the same sliding window, segments are non-overlapping, while sequences from different sliding windows may overlap.

Specifically, in order to ensure the integrity of local traffic patterns, the present disclosure employs a plurality of sliding windows that initiate partitioning from various starting points. This approach guarantees that if a local traffic pattern is disrupted in one sliding window, it may be extracted in another. A user's browsing instance is represented as (d, y), where d is a direction sequence of length l, and y is the label vector for the instance. If the instance includes the ith monitored website, then yi=1, otherwise yi=0. w represents the size of sliding windows, n represents the number of sliding windows. Prior to partitioning, the original sequence is replicated at its end to form a loop, ensuring uniform segment lengths. The starting position for the i^{th} sliding window is the i^{th} element in sequence d, with the resulting traffic segment collection denoted as Wᵢ={d[i+jw: i+jw+w]}, ∀j∈[0,└l/w┘−1], where each segment is mutually exclusive. The complete set of segment sequences derived from n sliding windows is denoted as S={W1 , . . . , Wn}, where overlapping of segment sequences extracted from different sliding windows is permissible.

In step S14, the key local patterns within subsequences is extracted using a convolutional neural network.

For instance, the local profiling module precisely extracts the local features of each direction sequence segment within the partitioned segment set S obtained from S13, which serves as the local patterns of the monitored website. Given that the positions of packet sequences representing different local traffic patterns are not fixed, and traffic packets from other sites or defensive traffic can introduce noise interference, existing models based on linear Transformer are not well-suited to this problem due to their sensitivity to packet positions and noise. Considering the CNN's ability to obtain relatively stable embedding vectors from variable inputs and its robustness to noise, the present disclosure leverages a convolutional neural network to extract local features.

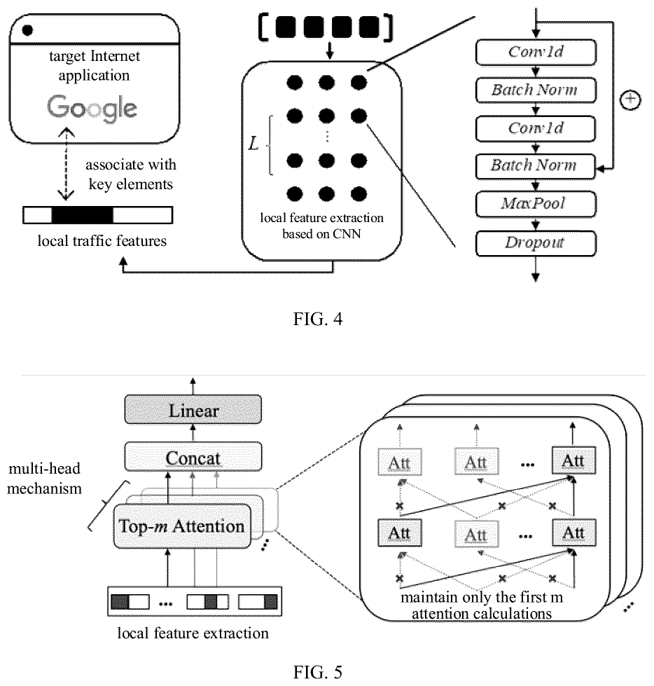

Specifically, as shown in FIG. 4, the convolutional neural network (CNN) architecture of the local analysis module comprises L blocks, each containing two one-dimensional convolutional layers, two batch normalization layers with ReLU activation function, and a max pooling layer. In addition, the following two mechanisms are provided to further improve the capabilities of our model. Al: Residual connections. These involve the integration of intermediate outputs from lower layers with the results from higher layers to prevent gradient vanishing. A2: Dropout. This technique randomly omits certain neural units during training to mitigate the issue of overfitting.

Furthermore, the following details the workflow of the local profiling module in this specific implementation. The input for the first block is a segment s from the segmented set S, derived in step S13 and s∈{−1,1}^{W}, with the output of the first block serving as the input for the second block, and so on. Within each block, the input first passes through two convolutional layers and two Batch Norm layers to extract local features. These local feature vectors, which are the output of the last Batch Norm layer combined with the original input, are then fed into the max pooling layer. This layer is designed to capture the most representative features while filtering out some noise. Specifically, defining x as the block input, the block output B(x) can be computed using the following equation:

B(x)=Dropout(MaxPool(F(F(x))+x)),

F(x) includes a convolutional layer followed by a Batch Norm layer that uses ReLU as its activation function, specifically:

F(x)=ReLU(BN(Conv1d(x))).

Embodiments of the present disclosure utilize a convolutional neural network (CNN) to extract the traffic patterns of each segment. Considering that the positions of packet sequences representing different local traffic patterns are not fixed, and there is noise interference from unrelated sequences of other website traffic within the same segment, the present disclosure employs a convolutional neural network due to its robustness against inputs with positional deviations to extract local features.

In step S15, the Transformer model is employed to analyze the correlations between different local traffic patterns and to calculate the probability of the obfuscated traffic containing the target website.

It is understood that the website identification module analyzes the correlations of local features from different segments to determine the probability of a single website being accessed in a session. The attention mechanism within the Transformer architecture is apt for addressing this issue. This mechanism is utilized to compute the relevance between a query and a set of key-value pairs, where the query vector, key vector, and value vector are all derived from the input vector through different matrix projections. The workflow of the attention mechanism is as follows: Firstly, the weight of each value vector is calculated based on the query vector and its corresponding key vector. Then, the weighted sum of all value vectors is computed as a measure of relevance between different queries and key-value pairs. When this method is applied to different segments of the same sequence, it is referred to as self-attention, which can transform the original sequence into a representation that captures its internal correlations. By employing the self-attention mechanism, the local feature vectors are used as input, with the output serving as the fingerprint of the monitored website. Specifically, let X be the input matrix with dimensions b*dₘ, where b is a batch size: W^{Q}, W^{K}, W^{V} are the parameter matrices used for projection with dimensions dₘ*d, where d is the dimension of the output vector, and these projection matrices are learned and updated during training: Q, K, V are defined as the query matrix, key matrix, and value matrix, respectively.

The workflow of the attention mechanism is as follows. A1, the matrices Q, K, and V are calculated by applying the input matrix and projection matrices. The specific computation formula is as follows:

Q=XW^{Q} K=XW^{K} V=XW^{V},

A2, output is calculated by using the attention function. The attention function calculates the dot product of each query vector with all key vectors, normalizes by division by \sqrt{d}, and then applies the softmax function to obtain the weights for each value vector and compute their weighted sum. The specific computation formula is as follows:

Attention(Q,K,V)=softmax(QK^{T}/\sqrt{d})V

However, due to noise from other website traffic and defensive traffic, directly applying the aforementioned attention mechanism in a multi-tab scenario is not an optimal choice. Specifically, the mechanism includes a fully connected attention layer, hence the output vector is dependent on the relevance of this input vector to the local feature vectors of all other inputs, inevitably leading to compromised accuracy due to noise traffic. To address this issue, the present disclosure proposes an improved attention layer: top-m self-attention. Unlike the basic attention mechanism that computes the weighted sum of all values, the top-m attention layer calculates the output vector based only on the highest m weight values as determined by the queries and keys. Since the traffic from the monitored website has a low correlation with the traffic from other sites and the defensive traffic, the local features extracted from them will also have smaller weights according to the attention mechanism. The top-m self-attention mechanism can thus filter out these lower-weight values, thereby reducing noise. Specifically, the computation method for top-m is as follows:

$$\\ {{Attention}^{}}^{top - m} ( Q , K , V ) = softmax ( Γ ( {QK}^{T} / \sqrt{d} ) ) V$$

$$\\ {[ Γ ( A ) ]}_{ij} \{ \begin{matrix}{A}_{ij} , {A}_{ij} represent the maximum m elements in {{j}^{}}^{th} row \\ ϵ , others\end{matrix}$$

where, Γ represents a selection operation that chooses the max m elements at the granularity of rows, and ϵ is a very small constant.

As shown in FIG. 5, the website identification module of the present disclosure parallelizes a plurality of top-m attention layers to form a multi head top-m attention layer. This enables each classifier, Trans-WF, to calculate the correlations of local features extracted from different sliding windows, thus acquiring a more precise fingerprint for each website. Its workflow is as follows.

A1, for the i^{th} head, define Wᵢ^{Q}, Wᵢ^{K}, Wᵢ^{V} as the projection matrix corresponding to this head, all of which are d*dₕ dimensional matrices, where dₕ is the dimension of the output vector of this head. h represents the number of heads, and let dₕ=d/h be set accordingly. The output of the i^{th} head may be calculated using the following equation:

headᵢ=Attention^{top-m}(QWᵢ^{Q},KWᵢ^{K},VWᵢ^{V}),

Each head may be computed independently and concurrently.

A2, the results from all heads are connected to obtain the output of the attention layer through a linear projection function. Specifically, W^{O} represents a weight matrix, which is a matrix of dimensions hdₕ*d, and let Λ(X) be the output of the multi head top-m attention layer, then it can be computed using the following equation:

Λ(X)=Concat(head₁, . . . , headₕ)W^{O}

A3, after calculating the output of the attention layer, a normalization layer and a multilayer perceptron (MLP) are utilized to identify the probability of a specific target website's occurrence. Residual connections and the Dropout mechanism are also introduced to prevent issues of gradient vanishing and overfitting. Specifically, LN is defined as the computation of the normalization layer, g and b are defined as the gain and bias parameters respectively, μ and σ are defined as the mean and variance of X, ⊙ is defined as the element-wise multiplication between two vectors, and ϵ is defined as a small constant to avoid division by zero. If the MLP utilizes a softmax function, then the result Φ(X) for the target website may be calculated using the following equation:

$$\\ Φ ( X ) = M L P ( LN ( X + Dropout ( Λ ( X ) ) ) ) ,$$

$$\\ LN ( X ) = \frac{g}{\sqrt{{{σ}^{}}^{2} + ϵ}} ⊙ ( X - μ ) + b$$

An embodiment of the present disclosure features a Transformer-based target website identification module responsible for calculating the probability of a specific website being accessed during a user's browsing session. To eliminate interference from traffic of other websites and defensive flows, only traffic segments with higher relevance are considered, and their correlations are computed to serve as the fingerprint for a specific monitored website, thereby filtering out noise traffic. Moreover, by capturing the correlations of local patterns extracted from multiple sliding windows, a more precise website fingerprint is obtained.

In step S16, all classifiers are integrated to identify the collection of dark websites accessed by Tor users.

Specifically, the results from different website classifiers are integrated and sorted in descending order, ultimately outputting the set of websites predicted to have been browsed by the user during the session.

According to the embodiment of the present disclosure, the method for identifying dark web sites in a scenario where a plurality of pages are accessed simultaneously is provided, which treats website identification in a multi-tab environment as a multi-label classification problem. A model architecture comprising a plurality of binary classifiers is designed, overcoming the existing methods' limitation of requiring the number of accessed web pages. For each classifier, our proposed Trans-WF model can identify specific websites without depending on pure traffic patterns from a single website. By collecting extensive traffic data in multi-tab scenarios under both closed-world and open-world settings, the method proposed in the present disclosure improves identification accuracy and maintains robustness even against various defensive measures. In summary, this approach can be better applied to multi-label website identification in real-world scenarios.

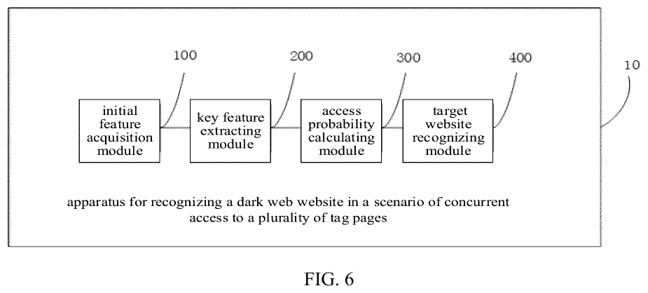

In order to achieve the above-mentioned embodiments, as shown in FIG. 6, an apparatus 10 for identifying dark web website in a scenario where a plurality of pages are accessed simultaneously is also provided in embodiments. The apparatus 10 includes an initial feature obtaining module 100, a key feature extracting module 200, an access probability calculating module 300, and a target website identifying module 400.

The initial feature obtaining module 100 is configured to obtain a browsed network traffic packet of a website to be identified, and extracting direction sequence features from the network traffic packet.

The key feature extracting module 200 is configured to divide the direction sequence features into a plurality of subsequence features based on a plurality of sliding windows, and input the plurality of subsequence features into a neural network model to extract preset pattern features.

The access probability calculating module 300 is configured to analyze a correlation of the preset pattern features using a target website identification model to obtain a probability determining result of a target website being accessed.

The target website identifying module 400 is configured to obtain a target website identification result in the website to be identified based on the probability determining result and a preset classification model.

The classification model includes a plurality of binary classifiers, which is configured to identify whether each website is included in the target website.

Further, the key feature extracting module 200 is further configured to splice the direction sequence features to obtain a traffic loop feature: and segment the traffic loop feature from different positions by using the plurality of sliding windows to obtain the plurality of subsequence features.

Further, the neural network model includes a first analysis component and a second analysis component. The key feature extracting module 200 is further configured to input the plurality of subsequence features into a convolutional layer and a Batch Norm layer of the first analysis component to output a first local feature vector, connect the first local feature vector with the plurality of subsequence features, input it into a max pooling layer of the first analysis component to output a first local pattern feature: input the first local pattern feature into a convolutional layer and a Batch Norm layer of the second analysis component to output a second local feature vector, connect the second local feature vector with the first local feature vector, input it into a max pooling layer of the second analysis component to output the second local pattern feature.

Further, the target website identification model includes a multi head top-m attention layer. The access probability calculating module 300 is further configured to obtain a projection matrix of the head of the preset number based on the second local pattern feature and the multi head top-m attention layer, and obtain an output result of the head of the preset number based on the projection matrix and a first preset formula: obtain an output result of the multi head top-m attention layer based on the output result of the head of the preset number and a linear projection function and using a second preset formula: obtain the probability determining result of the target website being accessed by using a third preset formula and according to the output result of the multi head top-m attention layer and a preset network rule.

According to embodiments of the present disclosure, the method for identifying dark web sites in a scenario where a plurality of pages are accessed simultaneously is provided, which treats website identification in a multi-tab environment as a multi-label classification problem. A model architecture comprising a plurality of binary classifiers is designed, overcoming the existing methods' limitation of requiring the number of accessed web pages. For each classifier, trans-WF model is provided to identify specific websites without depending on pure traffic patterns from a single website. By collecting extensive traffic data in multi-tab scenarios under both closed-world and open-world settings, the method proposed in the present disclosure improves identification accuracy and maintains robustness even against various defensive measures.

In order to achieve the above-mentioned objectives, the present disclosure also provides device for identifying a dark web website in a scenario where a plurality of pages are accessed simultaneously, and the device includes a processor: and a memory for storing instructions executable by the processor.

The processor is configured to obtain a browsed network traffic packet of a website to be identified, and extract direction sequence features from the network traffic packet: divide the direction sequence features into a plurality of subsequence features based on a plurality of sliding windows, and input the plurality of subsequence features into a neural network model to extract preset pattern features: analyze a correlation of the preset pattern features using a target website identification model to obtain a probability determining result of a target website being accessed: and obtain a target website identification result in the website to be identified based on the probability determining result and a preset classification model.

Furthermore, the classification model comprises a plurality of binary classifiers configured to identify whether each website is included in the target website.

Furthermore, the processor is configured to: splice the direction sequence features to obtain a traffic loop feature: segment the traffic loop feature from different positions by using the plurality of sliding windows to obtain the plurality of subsequence features.

Furthermore, the processor is configured to: input the plurality of subsequence features into a convolutional layer and a Batch Norm layer of a first analysis component to output a first local feature vector, connect the first local feature vector with the plurality of subsequence features, and input it into a max pooling layer of the first analysis component to output a first local pattern feature: input the first local pattern feature into a convolutional layer and a Batch Norm layer of a second analysis component to output a second local feature vector, connect the second local feature vector with the first local feature vector, and input it into a max pooling layer of the second analysis component to output a second local pattern feature.

Furthermore, the processor is configured to obtain a projection matrix of a head of a preset number based on the second local pattern feature and the multi head top-m attention layer, and obtain an output result of the head of the preset number based on the projection matrix and a first preset formula: obtain an output result of the multi head top-m attention layer based on the output result of the head of the preset number and a linear projection function and using a second preset formula: obtain the probability determining result of the target website being accessed by using a third preset formula and according to the output result of the multi head top-m attention layer and a preset network rule.

In order to achieve the above-mentioned objectives, the present disclosure also provides a non-transitory computer-readable storage medium having stored therein instructions that, when executed by a processor, causes the processor to obtain a browsed network traffic packet of a website to be identified, and extract direction sequence features from the network traffic packet: divide the direction sequence features into a plurality of subsequence features based on a plurality of sliding windows, and input the plurality of subsequence features into a neural network model to extract preset pattern features: analyze a correlation of the preset pattern features using a target website identification model to obtain a probability determining result of a target website being accessed: obtain a target website identification result in the website to be identified based on the probability determining result and a preset classification model.

Furthermore, the classification model includes a plurality of binary classifiers configured to identify whether each website is included in the target website.

Furthermore, the processor is configured to splice the direction sequence features to obtain a traffic loop feature: segment the traffic loop feature from different positions by using the plurality of sliding windows to obtain the plurality of subsequence features.

Furthermore, the processor is configured to input the plurality of subsequence features into a convolutional layer and a Batch Norm layer of a first analysis component to output a first local feature vector, connect the first local feature vector with the plurality of subsequence features, and input it into a max pooling layer of the first analysis component to output a first local pattern feature: input the first local pattern feature into a convolutional layer and a Batch Norm layer of a second analysis component to output a second local feature vector, connect the second local feature vector with the first local feature vector, and input it into a max pooling layer of the second analysis component to output a second local pattern feature.

Furthermore, the processor is configured to obtain a projection matrix of a head of a preset number based on the second local pattern feature and the multi head top-m attention layer, and obtain an output result of the head of the preset number based on the projection matrix and a first preset formula: obtain an output result of the multi head top-m attention layer based on the output result of the head of the preset number and a linear projection function and using a second preset formula: obtain the probability determining result of the target website being accessed by using a third preset formula and according to the output result of the multi head top-m attention layer and a preset network rule.

The method and the device for identifying a dark web website in a scenario where a plurality of pages are accessed simultaneously in embodiments of the present disclosure may achieve accurate identification effects in situations where the number of pages opened by a user is unknown and dynamically changing, which is used for identifying a plurality of pages website in real scenarios. At the same time, for various methods of web fingerprint defense, the present disclosure may still achieve a more robust website identification ability compared to existing methods, because the top-m self attention mechanism design based on local traffic features proposed by the present disclosure may better eliminate the impact of noise. In summary, the present disclosure is not only a multi-tab website recognition method with practical application value, but also achieves robust identification against defense and concept drift effects.

Reference throughout this specification to “an embodiment”, “some embodiments”, “an example”, “a specific example” or “some examples” means that a particular feature, structure, material, or characteristic described in connection with the embodiment or example is included in at least one embodiment or example of the present disclosure. These terms in various places throughout this specification do not necessarily referring to the same embodiment or example of the present disclosure. Furthermore, the particular features, structures, materials, or characteristics may be combined in any suitable manner in one or more embodiments or examples. In addition, those skilled in the art may combine the different embodiments or examples described in this specification, as well as the features of different embodiments or examples, without mutual contradiction.

In addition, terms such as “first” and “second” are used herein for purposes of description and are not intended to indicate or imply relative importance or significance or to imply the number of indicated technical features. Thus, the feature defined with “first” and “second” may comprise one or more of these features. In the description of the present invention, “a plurality of” means two or more than two, unless specified otherwise

What is claimed is:

1. A method for identifying a dark web website in a scenario where a plurality of pages are accessed simultaneously, comprising:
obtaining browsed network traffic packets of websites to be identified, and extracting direction sequence features from the browsed network traffic packets;
dividing the direction sequence features into a plurality of subsequence features based on a plurality of sliding windows, and inputting the plurality of subsequence features into a neural network model to extract preset pattern features;
analyzing a correlation of the preset pattern features using a target website identification model to obtain a probability result of a target website being accessed; and
obtaining a target website identification result based on the probability result and a preset classification model.

2. The method according to claim 1, wherein the preset classification model comprises a plurality of binary classifiers configured to identify whether each website is included in the target website.

3. The method according to claim 1, wherein dividing the direction sequence features into the plurality of subsequence features based on the plurality of sliding windows comprises:
splicing the direction sequence features to obtain a traffic loop feature; and
segmenting the traffic loop feature from different positions by using the plurality of sliding windows to obtain the plurality of subsequence features.

4. The method according to claim 1, wherein the neural network model comprises a first analysis component and a second analysis component: and inputting the plurality of subsequence features into the neural network model to extract the preset pattern features comprises:
inputting the plurality of subsequence features into a convolutional layer and a Batch Norm layer of the first analysis component to output a first local feature vector, connecting the first local feature vector with the plurality of subsequence features, and inputting it into a max pooling layer of the first analysis component to output a first local pattern feature; and
inputting the first local pattern feature into a convolutional layer and a Batch Norm layer of the second analysis component to output a second local feature vector, connecting the second local feature vector with the first local feature vector, and inputting it into a max pooling layer of the second analysis component to output a second local pattern feature.

5. The method according to claim 4, wherein the target website identification model comprises a multi head top-m attention layer: analyzing the correlation of the preset pattern features by using the target website identification model to obtain the probability result of the target website being accessed comprises:
obtaining a projection matrix of a head of a preset number based on the second local pattern feature and the multi head top-m attention layer, and obtaining an output result of the head of the preset number based on the projection matrix and a first preset formula;
obtaining an output result of the multi head top-m attention layer based on the output result of the head of the preset number and a linear projection function and using a second preset formula; and
obtaining the probability result of the target website being accessed by using a third preset formula and according to the output result of the multi head top-m attention layer and a preset network rule.

6. A device for identifying a dark web website in a scenario where a plurality of pages are accessed simultaneously, comprising:
a processor; and
a memory for storing instructions executable by the processor;
wherein the processor is configured to:
obtain browsed network traffic packets of a website to be identified, and extract direction sequence features from the browsed network traffic packets;
divide the direction sequence features into a plurality of subsequence features based on a plurality of sliding windows, and input the plurality of subsequence features into a neural network model to extract preset pattern features; and
analyze a correlation of the preset pattern features using a target website identification model to obtain a probability result of a target website being accessed; and
obtain a target website identification result in the website to be identified based on the probability result and a preset classification model.

7. The device according to claim 6, wherein the preset classification model comprises a plurality of binary classifiers configured to identify whether each website is included in the target website.

8. The device according to claim 6, wherein the processor is configured to:
splice the direction sequence features to obtain a traffic loop feature; and
segment the traffic loop feature from different positions by using the plurality of sliding windows to obtain the plurality of subsequence features.

9. The device according to claim 6, wherein the processor is configured to:
input the plurality of subsequence features into a convolutional layer and a Batch Norm layer of a first analysis component to output a first local feature vector, connect the first local feature vector with the plurality of subsequence features, and input it into a max pooling layer of the first analysis component to output a first local pattern feature; and
input the first local pattern feature into a convolutional layer and a Batch Norm layer of a second analysis component to output a second local feature vector, connect the second local feature vector with the first local feature vector, and input it into a max pooling layer of the second analysis component to output a second local pattern feature.

10. The device according to claim 9, wherein the processor is configured to:
obtain a projection matrix of a head of a preset number based on the second local pattern feature and a multi head top-m attention layer, and obtain an output result of the head of the preset number based on the projection matrix and a first preset formula;
obtain an output result of the multi head top-m attention layer based on the output result of the head of the preset number and a linear projection function and using a second preset formula; and
obtain the probability result of the target website being accessed by using a third preset formula and according to the output result of the multi head top-m attention layer and a preset network rule.

11. A non-transitory computer-readable storage medium having stored therein instructions that, when executed by a processor, causes the processor to:
obtain browsed network traffic packets of a website to be identified, and extract direction sequence features from the browsed network traffic packets;
divide the direction sequence features into a plurality of subsequence features based on a plurality of sliding windows, and input the plurality of subsequence features into a neural network model to extract preset pattern features;
analyze a correlation of the preset pattern features using a target website identification model to obtain a probability result of a target website being accessed; and
obtain a target website identification result in the website to be identified based on the probability result and a preset classification model.

12. The storage medium according to claim 11, wherein the preset classification model comprises a plurality of binary classifiers configured to identify whether each website is included the target website.

13. The storage medium according to claim 11, wherein the processor is configured to:
splice the direction sequence features to obtain a traffic loop feature; and
segment the traffic loop feature from different positions by using the plurality of sliding windows to obtain the plurality of subsequence features.

14. The storage medium according to claim 11, wherein the processor is configured to:
input the plurality of subsequence features into a convolutional layer and a Batch Norm layer of a first analysis component to output a first local feature vector, connect the first local feature vector with the plurality of subsequence features, and input it into a max pooling layer of the first analysis component to output a first local pattern feature; and
input the first local pattern feature into a convolutional layer and a Batch Norm layer of a second analysis component to output a second local feature vector, connect the second local feature vector with the first local feature vector, and input it into a max pooling layer of the second analysis component to output a second local pattern feature.

15. The storage medium according to claim 14, wherein the processor is configured to:
obtain a projection matrix of a head of a preset number based on the second local pattern feature and a multi head top-m attention layer, and obtain an output result of the head of the preset number based on the projection matrix and a first preset formula;
obtain an output result of the multi head top-m attention layer based on the output result of the head of the preset number and a linear projection function and using a second preset formula; and
obtain the probability result of the target website being accessed by using a third preset formula and according to the output result of the multi head top-m attention layer and a preset network rule.
